(19) United States
(12) Patent Application Publication
(10) Pub. No.: US 2016/0243629 A1
(43) Pub. Date: Aug. 25, 2016

(54) CLAMPED BEAM CUTTING TOOL

(71) Applicants: Darwin P. Shaw, Wabasca (CA); Noel Beaureguard, Wabasca (CA)

(72) Inventors: Darwin P. Shaw, Wabasca (CA); Noel Beaureguard, Wabasca (CA)

(21) Appl. No.: 14/630,380

(22) Filed: Feb. 24, 2015

(51) Int. Cl. B23D 45/04

(52) U.S. Cl. CPC B23D 45/042

(57) ABSTRACT

An apparatus for cutting a beam comprises a base member sized to be locatable upon a beam. The base member has a stationary first clamping surface and an opposed movable second clamping surface. The apparatus further comprises a saw pivotally mounted to the base member so as to be operable to be rotated between a first position wherein a blade of the saw is positioned to cut a beam clamped between the first and second clamping surfaces and a second position rotatably retracted therefrom. The base member includes a receiving surface adapted to receive a work piece thereon on a side opposite to the saw.

### BACKGROUND OF THE INVENTION

1. Field of Invention

The present invention relates to construction in general and in particular to a method and apparatus for cutting beams.

2. Description of Related Art

In the field of construction, it is commonly necessary to cut most building materials to the size required for that particular application. The process of cutting some materials however is frequently time consuming an inaccurate according to known methods for doing so.

In particular, in the case of structural beams and the like, such beams are commonly formed of metal I or T beams which are cut to length and subsequently welded or bolted together. One common method of cutting such beams is to use a cutting torch which are commonly available at a job site.

Disadvantageously such cutting torches are known to produce a rough or uneven cut which will depend greatly upon the skill of the person operating the torch. Cutting torches are also slow taking

### SUMMARY OF THE INVENTION

According to a first embodiment of the present invention there is disclosed apparatus for cutting a beam comprising a base member sized to be locatable upon a beam. The base member has a stationary first clamping surface and an opposed movable second clamping surface. The apparatus further comprises a saw pivotally mounted to the base member so as to be operable to be rotated between a first position wherein a blade of the saw is positioned to cut a beam clamped between the first and second clamping surfaces and a second position rotatably retracted therefrom. The base member includes a receiving surface adapted to receive a work piece thereon on a side opposite to the saw.

The first clamping surface may be located on a stationary clamping member. The stationary clamping member may extend substantially perpendicular from the base member. The stationary clamping member may comprise a substantially planar ember.

The second clamping surface may be located on a movable clamping member. The movable clamping member may be supported from a threaded rod. The threaded rod may be threadably received within a bore of the base member. The bore may be located within an extension from the base member. The threaded rod may include a handle at a distal end thereof.

The base member may comprise a substantially planar member. The planar member may include an opening therethrough. The saw may include a motor. The opening may have a shape corresponding to the saw and the motor so as to permit the saw to pass therethrough.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of an apparatus for cutting structural steel members according to a first embodiment of the present invention.

FIG. 2 is a side view of the apparatus of FIG. 1 being applied to a beam.

FIG. 3 is a side view of the apparatus of FIG. 1 cutting a beam.

FIG. 4 is a perspective view of the apparatus of FIG. 1 cutting a beam with the motor of the saw passing through the base member.

### DETAILED DESCRIPTION

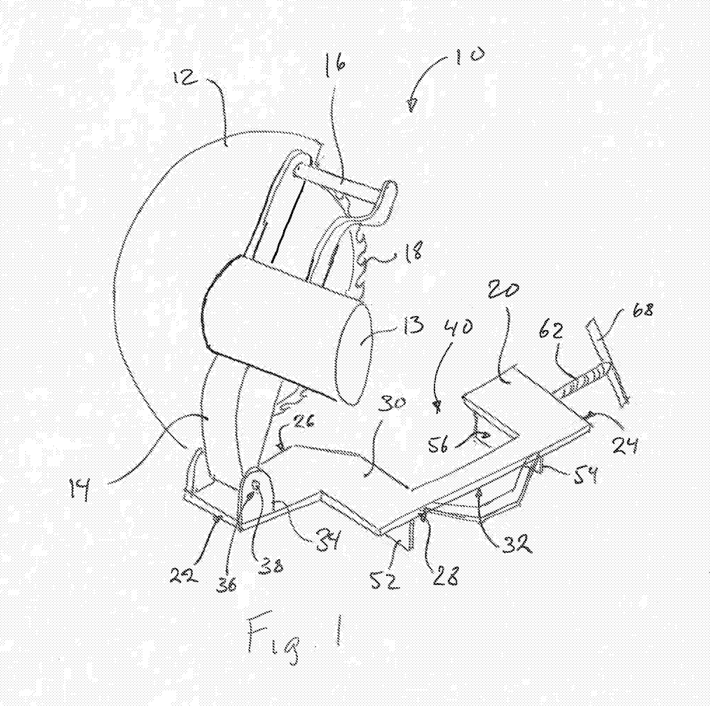

Referring to FIG. 1, an apparatus for cutting structural members according to a first embodiment of the invention is shown generally at 1. The apparatus comprises a saw 12 pivotally mounted to a base member 20. The saw 12 be of any conventional type such as, by way of non-limiting example, a circular saw. The saw 12 includes a motor 13 as is conventionally known having a bracket 14 extending therefrom for pivotal securement to the base member 20 as will be more fully described below. The saw 12 also includes a handle 16 for operation of the saw and a saw blade 18.

The base member 20 comprises a substantially planar member extending between first and second ends, 22 and 24, respectively and first and second side edges 26 and 28, respectively. The base member 20 has top and bottom surfaces, 30 and 32, respectively. The bottom surface 32 is adapted to receive a work piece to be cut. The first end 22 includes a pair of parallel spaced apart pivot plates 34 extending from the top surface 32. The pivot plates 34 have a distance therebetween selected to receive the bracket 14 of the saw therein. The pivot plates 34 also include bores 36 therethrough sized to receive a pin 38 therethrough. The bracket 14 includes a corresponding bore (not shown) sized to receive the pin 38 therein so as to pivotally support the bracket 14 between the pivot plates 34.

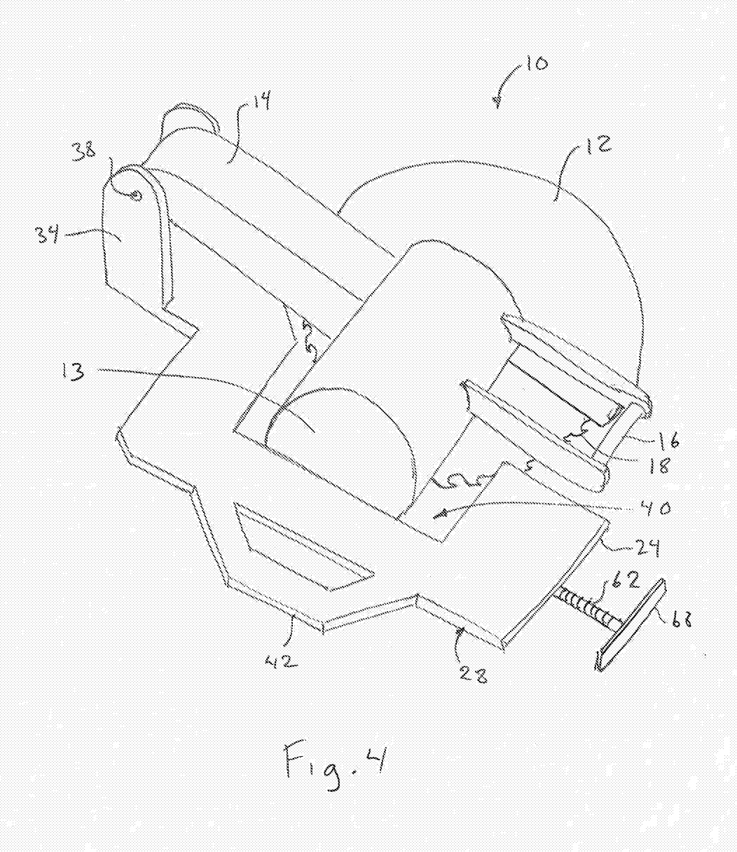

The base member 20 includes an opening 40 therethrough sized and shaped to permit the motor 13 and any other protruding portions of the saw 12 to pass therethrough as illustrated in FIG. 4. The first side edge 26 is positioned to the same side of the saw blade 18 as the motor 13 so as to prevent the saw blade 18 from contacting the base member. The base member 20 may also include a handle 42 or the like extending therefrom for use in carrying or transporting the apparatus.

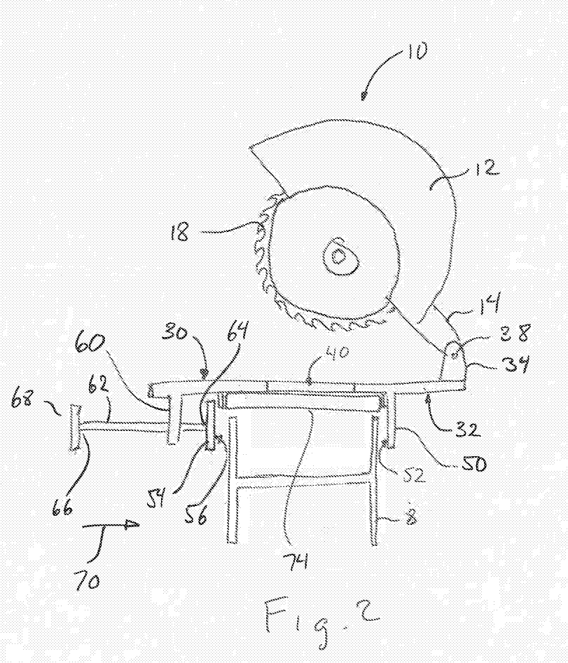

The base member 20 includes a first clamping member 50 extending from the bottom surface 32 having a first clamping surface 52 thereon. The base member 20 also includes a second clamping member 54 located proximate to the bottom surface having a second clamping surface 56 located thereon. As illustrated in FIG. 2, the first and second clamping surfaces 52 and 56 are opposed and oriented towards each other so as to be operable to clamp a work piece therebetween. As illustrated in FIG. 2, the base member 20 also includes a base bracket 60 extending from the bottom surface 32. The bottom bracket includes a bore (not shown) therethrough threaded to receive a threaded rod 62 therethrough. The threaded rod 62 extends between first and second ends, 64 and 66, respectively wherein the second clamping member 54 is located at the first end 64 thereof. The second end 66 of the threaded rod 64 has a handle 68 or other suitable means for rotating the threaded rod.

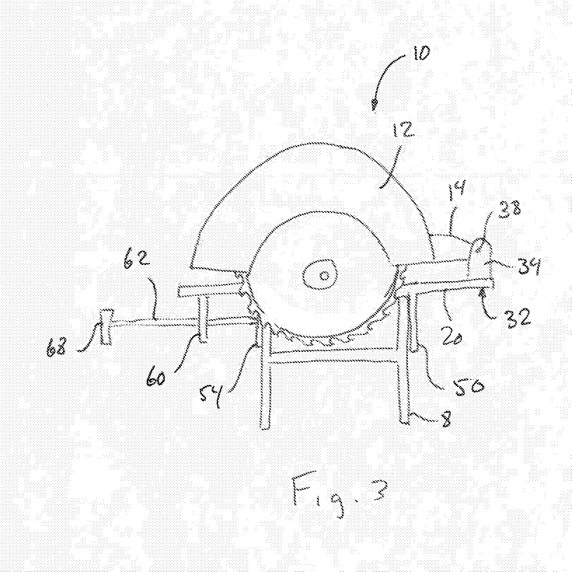

With reference to FIGS. 2 through 4, in operation, the apparatus 10 may be located on a work piece, such as, by way of non-limiting example, a beam 8 or the like. Thereafter as illustrated in FIG. 2, the handle 68 may be rotated so as to engage the second clamping member upon the beam 8 in a direction generally indicated at 70 so as to clamp it between the first and second clamping surfaces 52 and 56 proximate to the bottom surface 32. It will be appreciated that the location of the beam under the base member, or on the opposite side of the base member than the saw 12 permits the apparatus to be supported by the work piece which will assist in the operation of the apparatus in a variety of locations including a shop. Once the first and second clamping surfaces 52 and 56 have been secured to a work piece, the saw 12 may be turned on and rotated in a downward direction as illustrated in FIG. 3 in a direction generally indicated at 72 so as to cause the saw blade 18 to cut the beam 8. As set out above, the opening 40 is positioned and sized so as to permit the motor and other structures on the saw 12 to pass therethrough when it is necessary to cut a beam further below the base member 20 than the radius of the saw blade 18. As illustrated in FIG. 2, the base member 20 may also include a roller 74 or other suitable low friction member along the bottom surface 32 thereof, such as by way of non-limiting example, a bushing to permit the apparatus to be slidingly moved along the beam for during repositioning.

While specific embodiments of the invention have been described and illustrated, such embodiments should be considered illustrative of the invention only and not as limiting the invention as construed in accordance with the accompanying claims.

What is claimed is:

1. An apparatus for cutting a beam comprising:
a base member sized to be locatable upon a beam, said base member having a stationary first clamping surface and an opposed movable second clamping surface; and
a saw pivotally mounted to said base member so as to be operable to be rotated between a first position wherein a blade of said saw is positioned to cut a beam clamped between said first and second clamping surfaces and a second position rotatably retracted therefrom,
wherein said base member includes a receiving surface adapted to receive a work piece thereon on a side opposite to said saw.

2. The apparatus of claim 1 wherein said first clamping surface is located on a stationary clamping member.

3. The apparatus of claim 2 wherein said stationary clamping member extends substantially perpendicular from said base member.

4. The apparatus of claim 3 wherein said stationary clamping member comprises a substantially planar ember.

5. The apparatus of claim 1 wherein said second clamping surface is located on a movable clamping member.

6. The apparatus of claim 5 wherein said movable clamping member is supported from a threaded rod.

7. The apparatus of claim 6 wherein said threaded rod is threadably received within a bore of said base member.

8. The apparatus of claim 7 wherein said bore is located within an extension from said base member.

9. The apparatus of claim 6 wherein said threaded rod includes a handle at a distal end thereof.

10. The apparatus of claim 1 wherein said base member comprises a substantially planar member.

11. The apparatus of claim 10 wherein said planar member includes an opening therethrough.

12. The apparatus of claim 11 wherein said saw includes a motor.

13. The apparatus of claim 12 wherein said opening has a shape corresponding to said saw and said motor so as to permit said saw to pass therethrough.
